(19) United States
(12) Patent Application Publication
(10) Pub. No.: US 2006/0177336 A1
(43) Pub. Date: Aug. 10, 2006

(54) Dual-piston valve for orbiting vane compressors

(75) Inventors: Seon-woong Hwang, Anyang-Si (KR); Dong-won Yoo, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/208,717

(22) Filed: Aug. 23, 2005

(30) Foreign Application Priority Data
Feb. 4, 2005 (KR) 10-2005-0010709

(51) Int. Cl. F04C 18/00; F01C 20/18; F16N 13/20; F01C 1/02

(52) U.S. Cl. 418/59; 418/58; 418/29

(57) ABSTRACT

Disclosed herein is a dual-piston valve for orbiting vane compressors. The dual-piston valve comprises a valve housing having a pair of piston operation spaces defined therein and a pair of pistons disposed in the piston operation spaces of the valve housing such that the pistons can be vertically moved to open or close inner and outer outlet ports formed at a cylinder. At one end of the valve housing are formed a pair of through-holes, which communicate with the piston operation spaces, respectively. Gas outlet ports are formed at opposite longitudinal sides of the valve housing. With the above-stated construction, compressed refrigerant gas is properly discharged, and therefore, performance of the orbiting vane compressor is prevented from being deteriorated due to over-compression loss of refrigerant gas.

### BACKGROUND OF THE INVENTION

1. Field of the Invention

The present invention relates to an orbiting vane compressor, and, more particularly, to a dual-piston valve for orbiting vane compressors that can be easily and conveniently mounted at inner and outer outlet ports of the orbiting vane compressor and that is capable of preventing performance of the orbiting vane compressor from being deteriorated due to over-compression loss of refrigerant gas.

2. Description of the Related Art

Generally, an orbiting vane compressor is constructed to compress refrigerant gas introduced into a cylinder through an orbiting movement of an orbiting vane in the cylinder having an inlet port. Various types of orbiting vane compressors, which are classified based on their shapes, have been proposed.

FIG. 1 is a longitudinal sectional view illustrating the overall structure of a conventional rotary-type orbiting vane compressor. As shown in FIG. 1, a drive unit D and a compression unit P, which is disposed below the drive unit D, are mounted in a shell 1 while the drive unit D and the compression unit P are hermetically sealed. The drive unit D and the compression unit P are connected to each other via a vertical rotary shaft 6, which has an eccentric part 6a.

The drive unit D comprises: a stator 2 fixedly disposed in the shell 1; and a rotor 3 disposed in the stator 2 for rotating the rotary shaft 6, which vertically extends through the rotor 3, when electric current is supplied to the rotor 3.

The compression unit P comprises an orbiting vane 4 for performing an orbiting movement in a cylinder 5 by the eccentric part 6a of the rotary shaft 6. As the orbiting vane 4 performs the orbiting movement in the cylinder 5, refrigerant gas introduced into the cylinder 5 through an inlet port 51 is compressed. The cylinder 5 has an inner ring 52. Between the inner ring 52 and the inner wall of the cylinder 5 is defined an annular operation space 53. A wrap 40 of the orbiting vane 4 performs an orbiting movement in the operation space 53. As a result, compression chambers are formed at the inside and the outside of the wrap 40, respectively.

At the upper and lower parts of the compression unit P are disposed a main bearing 7 and a subsidiary bearing 7a, which support opposite ends of the rotary shaft 6. As shown in FIG. 3, the subsidiary bearing 7a has inner and outer outlet ports 53a and 53b, which extend through the cylinder 5. At the inner and outer outlet ports 53a and 53b of the subsidiary bearing 7a are disposed reed valves 53c, each of which is a discharge valve formed in the shape of a plate spring. Also, the subsidiary bearing 7a has a discharge chamber 8a, which is formed by a muffler 8. The discharge chamber 8a is connected to a pipe-shaped discharge channel 9, which extends vertically through the compression unit P and the main bearing 7, such that the compressed refrigerant gas is discharged into the shell 1 through the discharge channel 9.

Unexplained reference numeral 11 indicates an inlet tube, 12 an outlet tube, and 10a an Oldham's ring for preventing rotation of the wrap 40 of the orbiting vane 4.

When electric current is supplied to the drive unit D, the rotor 3 of the drive unit D is rotated, and therefore, the rotary shaft 6, which vertically extends through the rotor 3, is also rotated. As the rotary shaft 6 is rotated, the orbiting vane 4 attached to the eccentric part 6a of the rotary shaft 6 performs an orbiting movement.

As a result, the wrap 40 of the orbiting vane 4 performs an orbiting movement in the operation space 53 of the cylinder 5 to compress refrigerant gas introduced into the cylinder 5 through the inlet port 51 in the compression chambers formed at the inside and the outside of the wrap 40, respectively. The compressed refrigerant gas is discharged into the discharge chamber 8a through the cylinder 5 and the inner and outer outlet ports 53a and 53b of the subsidiary bearing 7a. The discharged high-pressure refrigerant gas is guided into the shell 1 through the discharge channel 9. Finally, the compressed refrigerant gas is discharged out of the shell 1 through the outlet tube 12.

FIG. 2 is a plan view, in section, illustrating the compressing operation of the conventional orbiting vane compressor shown in FIG. 1.

As shown in FIG. 2, the wrap 40 of the orbiting vane 4 of the compression unit P performs an orbiting movement in the operation space 53 of the cylinder 5, as indicated by arrows, to compress refrigerant gas introduced into the operation space 53 through the inlet port 51. The orbiting movement of the wrap 40 of the orbiting vane 4 will be described hereinafter in more detail.

At the initial orbiting position of the wrap 40 of the orbiting vane 4 of the compression unit P (i.e., the 0-degree orbiting position), refrigerant gas is introduced into an inner suction chamber A1, which is disposed at the inside of the wrap 40, through the inlet port 51, and compression is performed in an outer compression chamber B2, which is disposed at the outside of the wrap 40, while the outer compression chamber B2 does not communicate with the inlet port 51 and an outer outlet port 53b. Refrigerant gas is compressed in an inner compression chamber A2, and at the same time, the compressed refrigerant gas is discharged out of the inner compression chamber A2.

At the 90-degree orbiting position of the wrap 40 of the orbiting vane 4 of the compression unit P, the compression is still performed in the outer compression chamber B2, and almost all the compressed refrigerant gas is discharged out of the inner compression chamber A2 through an inner outlet port 53a. At this stage, an outer suction chamber B1 appears so that refrigerant gas is introduced into the outer suction chamber B1 through the inlet port 51.

At the 180-degree orbiting position of the wrap 40 of the orbiting vane 4 of the compression unit P, the inner suction chamber A1 disappears. Specifically, the inner suction chamber A1 is changed into the inner compression chamber A2, and therefore, compression is performed in the inner compression chamber A2. At this stage, the outer compression chamber B2 communicates with the outer outlet port 53b. Consequently, the compressed refrigerant gas is discharged out of the outer compression chamber B2 through the outer outlet port 53b.

At the 270-degree orbiting position of the wrap 40 of the orbiting vane 4 of the compression unit P, almost all the compressed refrigerant gas is discharged out of the outer compression chamber B2 through the outer outlet port 53b, and the compression is still performed in the inner compression chamber A2. Also, compression is newly performed in the outer suction chamber B1. When the orbiting vane 4 of the compression unit P further performs the orbiting movement by 90 degrees, the outer suction chamber B1 disappears. Specifically, the outer suction chamber B1 is changed into the outer compression chamber B2, and therefore, the compression is continuously performed in the outer compression chamber B2. As a result, the wrap 40 of the orbiting vane 4 of the compression unit P is returned to the position where the orbiting movement of the orbiting vane 4 is initiated. In this way, a 360-degree-per-cycle orbiting movement of the wrap 40 of the orbiting vane 4 of the compression unit P is accomplished. The orbiting movement of the wrap 40 of the orbiting vane 4 of the compression unit P is performed in a continuous fashion.

FIG. 3 is a plan view, in section, illustrating another example of the compression unit of the conventional orbiting vane compressor shown in FIG. 1.

As shown in FIG. 3, an annular operation space 53 is formed in the cylinder 5. The annular operation space 53 has opposite ends separated from each other by a closing part 58. The outlet port side operation space 53 has a linear part 59, although the other part of the operation space 53 is approximately formed in the shape of a ring. The wrap 40, which performs an orbiting movement in the operation space 53, is configured such that the length of the wrap 40 is less than that of the operation space 53. The wrap 40 is disposed in the operation space 53 such that the operation space 53 at the inside of the wrap 40 communicates with the operation space 53 at the outside of the wrap 40 at the inlet port side of the cylinder 5.

A linear slider 55 is disposed in the linear part 59 of the operation space 53 such that the linear slider 55 can be slid. In the operation space 53 between the linear slider 55 and the closing part 58 is formed a gas discharge hole 57. The linear slider 55 is brought into tight contact with the outlet port side end of the wrap 40 of the orbiting vane 4 by the discharge pressure of the high-pressure refrigerant gas, which is discharged through the gas discharge hole 57 of the operation space 53, whereby sealing is maintained between the linear slider 55 and the wrap 40 of the orbiting vane 4. Consequently, frictional loss due to biased contact between the linear slider and the wrap of the orbiting vane is greatly reduced.

FIG. 4 is a perspective view illustrating the lower part of the subsidiary bearing 7a of the conventional orbiting vane compressor shown in FIG. 1.

Generally, the subsidiary bearing 7a has inner and outer outlet ports 53a and 53b, through which refrigerant gas compressed by the compression unit P is discharged. At the inner and outer outlet ports 53a and 53b of the subsidiary bearing 7a are disposed reed valves 53c, each of which is a discharge valve formed in the shape of a plate spring. The reed valves 53c are configured to open or close the inner and outer outlet ports 53a and 53b of the subsidiary bearing 7a by the difference in pressure between the refrigerant gas discharged through the inner and outer outlet ports 53a and 53b of the subsidiary bearing 7a and the compressed refrigerant gas in the discharge chamber 8a, and rigidity of the valves.

However, the conventional reed valves are designed to have relatively high rigidity, which is necessary to improve reliability of the reed valves. As a result, gas compressed in the cylinder may not overcome the rigidity of the reed valves, and therefore, the compressed gas may not be discharged through the inner and outer outlet ports. Consequently, performance of the compressor is deteriorated due to over-compression loss of refrigerant gas.

Furthermore, each of the reed valves is formed in the shape of a plate spring. That is, the length of each of the reed valves is greater than the width of each of the reed valves. As a result, it is not easy to mount the reed valves at the inner and outer outlet ports, which are disposed adjacent to each other, and therefore, assembly efficiency is lowered. Furthermore, the reed valves repetitively collide with the subsidiary bearing when the reed valves are operated, and therefore, noise is generated.

### SUMMARY OF THE INVENTION

Therefore, the present invention has been made in view of the above problems, and it is an object of the present invention to provide a dual-piston valve for orbiting vane compressors that can be easily and conveniently mounted at inner and outer outlet ports, through which refrigerant gas compressed in a cylinder through an orbiting movement of an orbiting vane is discharged, and that is capable of preventing performance of the orbiting vane compressor from being deteriorated due to over-compression loss of refrigerant gas.

It is another object of the present invention to provide a dual-piston valve for orbiting vane compressors that is capable of greatly reducing noise generated when a pair of pistons disposed in a valve housing repetitively collide with the valve housing due to discharge pressure of refrigerant gas discharged through the inner and outer outlet ports of the cylinder, whereby operability of the dual-piston valve is improved.

In accordance with the present invention, the above and other objects can be accomplished by the provision of a dual-piston valve for orbiting vane compressors comprising: a valve housing having a pair of piston operation spaces defined therein, a pair of through-holes formed at one end thereof, which communicate with the piston operation spaces, respectively, and gas outlet ports formed at opposite longitudinal sides thereof; and a pair of pistons disposed in the piston operation spaces of the valve housing such that the pistons can be vertically moved to open or close inner and outer outlet ports formed at a cylinder.

Preferably, the gas outlet ports have heights less than those of the pistons.

Preferably, the dual-piston valve for orbiting vane compressors further comprises: resilient supporting members disposed in the piston operation spaces of the valve housing between the through-holes and the pistons, respectively, for resiliently supporting the corresponding pistons in the direction in which the inner and outer outlet ports of the cylinder are closed.

Preferably, the resilient supporting members are compression coil springs, and each of the compression coil springs has a diameter greater than that of the corresponding through-hole.

Preferably, the dual-piston valve for orbiting vane compressors further comprises: fixing members for fixing the valve housing to the cylinder above the inner and outer outlet ports of the cylinder, and the fixing members are fixing bosses integrally formed at the valve housing, the fixing bosses being disposed at opposite lateral sides of the valve housing between the through-holes in the direction perpendicular to the line connecting the centers of the through-holes.

Preferably, each of the fixing bosses has at least two supporting ribs integrally formed at the upper or lower part of the outer circumference thereof such that the supporting ribs are arranged symmetrically to each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view illustrating the overall structure of a conventional rotary-type orbiting vane compressor;

FIG. 2 is a plan view, in section, illustrating the compressing operation of the conventional orbiting vane compressor shown in FIG. 1;

FIG. 3 is a plan view, in section, illustrating another example of the compression unit of the conventional orbiting vane compressor shown in FIG. 1;

FIG. 4 is a perspective view illustrating the lower part of the subsidiary bearing of the conventional orbiting vane compressor shown in FIG. 1;

FIG. 5 is a perspective view illustrating the lower part of a subsidiary bearing of an orbiting vane compressor, to which a dual-piston valve according to the present invention is applied;

FIG. 6 is an exploded perspective view illustrating a dual-piston valve for orbiting vane compressors according to a first preferred embodiment of the present invention;

FIG. 7A is a sectional view illustrating the closing operation of the dual-piston valve for orbiting vane compressors according to the first preferred embodiment of the present invention shown in FIG. 6;

FIG. 7B is a sectional view illustrating the opening operation of the dual-piston valve for orbiting vane compressors according to the first preferred embodiment of the present invention shown in FIG. 6;

FIG. 8 is an exploded perspective view illustrating a dual-piston valve for orbiting vane compressors according to a second preferred embodiment of the present invention;

FIG. 9A is a sectional view illustrating the closing operation of the dual-piston valve for orbiting vane compressors according to the second preferred embodiment of the present invention shown in FIG. 8; and

FIG. 9B is a sectional view illustrating the opening operation of the dual-piston valve for orbiting vane compressors according to the second preferred embodiment of the present invention shown in FIG. 8.

### DESCRIPTION OF THE PREFERRED EMBODIMENTS

Now, preferred embodiments of the present invention will be described in detail with reference to the accompanying drawings.

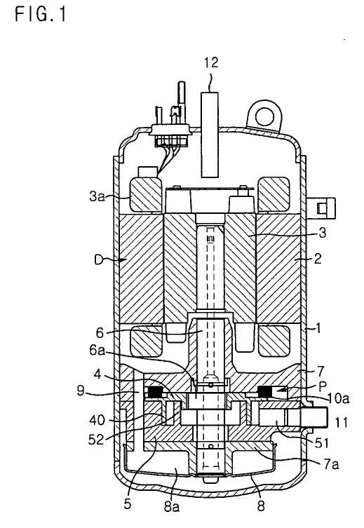

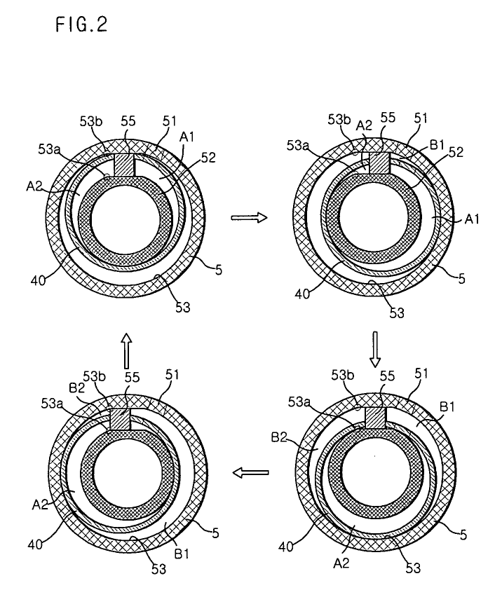

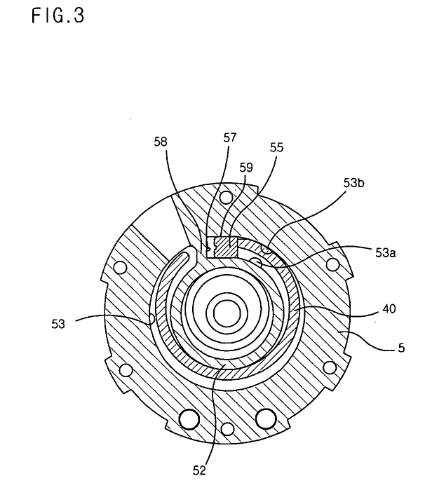

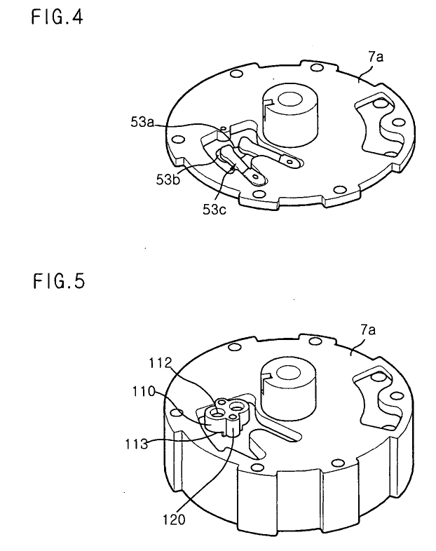

Generally, a rotary-type orbiting vane compressor comprises a drive unit D and a compression unit P, which is disposed below the drive unit D. The compression unit P is connected to the drive unit D via a rotary shaft 6. The rotary shaft 6 has opposite ends supported by a main bearing 7 and a subsidiary bearing 7a disposed at the upper and lower parts of the compression unit P. As shown in FIG. 3, the subsidiary bearing 7a has inner and outer outlet ports 53a and 53b, which extend through a cylinder 5 (see FIG. 1).

FIG. 5 is a perspective view illustrating the lower part of a subsidiary bearing 7a of an orbiting vane compressor, to which a dual-piston valve according to the present invention is applied.

As shown in FIG. 5, the dual-piston valve comprises a valve housing 110, which is formed in the shape of a cap. The valve housing 110 is mounted to the subsidiary bearing 7a above the inner and outer outlet ports 53a and 53b of the subsidiary bearing 7a. The dual-piston valve further comprises fixing bosses 120, via which the valve housing 110 is mounted to the subsidiary bearing 7a above the inner and outer outlet ports 53a and 53b of the subsidiary bearing 7a. The valve housing 110 has gas outlet ports 113, which are formed at opposite longitudinal sides of the valve housing 110 between the fixing bosses 120.

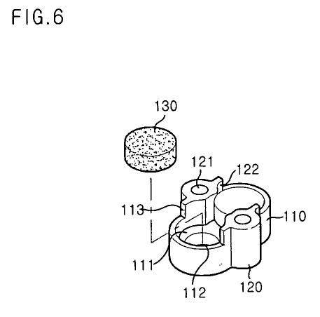

The dual-piston valve will now be described in more detail with reference to FIG. 6.

FIG. 6 is an exploded perspective view illustrating a dual-piston valve for orbiting vane compressors according to a first preferred embodiment of the present invention.

As shown in FIG. 6, the valve housing 110 is formed in the shape of two combined cylindrical members whose diameters are slightly greater than those of the inner and outer outlet ports 53a and 53b of the subsidiary bearing 7a, respectively. The lower ends of the two combined cylindrical members constituting the valve housing 110 are closed. The valve housing 110 has a pair of piston operation spaces 111 defined therein. The piston operation spaces 111 communicate with the inner and outer outlet ports 53a and 53b of the subsidiary bearing 7a, respectively.

At the lower end of the valve housing 110 are formed a pair of through-holes 112, which communicate with the piston operation spaces 111, respectively, such that the pressure of the high-pressure refrigerant gas discharged from the discharge chamber is applied to the piston operation spaces 111 through the through-holes 112. Preferably, the diameter of each of the through-holes 112 is less than that of the corresponding piston operation space 111. At the valve housing 110 are integrally formed fixing bosses 120, which are disposed at opposite lateral sides of the valve housing 110 between the through-holes 112 in the direction perpendicular to the line connecting the centers of the through-holes 112. The valve housing 110 is securely fixed to the subsidiary bearing 7a via the fixing bosses 120.

Each of the fixing bosses 120 has a fixing hole 121, which is vertically formed through the center part of the corresponding fixing boss 120. The gas outlet ports 113 are formed at the upper parts of opposite longitudinal sides of the valve housing 110 between the fixing bosses 120 such that high-pressure refrigerant gas discharged through the inner and outer outlet ports 53a and 53b of the subsidiary bearing 7a is discharged out of the valve housing 110 through the gas outlet ports 113.

In the piston operation spaces 111 of the valve housing 110 are disposed a pair of pistons 130, respectively, such that the pistons 130 can be vertically reciprocated in the corresponding piston operation spaces 111. Specifically, the pistons 130 are vertically moved in the corresponding piston operation spaces 111, by the discharge pressure of the compressed refrigerant gas discharged through the inner and outer outlet ports 53a and 53b of the subsidiary bearing 7a and the pressure of the high-pressure refrigerant gas pressure discharged from the discharge chamber and applied to the piston operation spaces 111 of the valve housing 110 through the through-holes 112.

Preferably, the heights of the gas outlet ports 113 formed at opposite longitudinal sides of the valve housing 110 between the fixing bosses 120 are less than those of the pistons 130 such that the pistons 130 are prevented from being separated from the valve housing 110 through the gas outlet ports 113.

At the upper part of the outer circumference of each of the fixing bosses 120 are integrally formed one or more supporting ribs 122, by which the valve housing 110 is stably and securely fixed to the subsidiary bearing 7a. Preferably, at least two supporting ribs 122 are formed at the outer circumferential part of each of the fixing bosses 120 such that the supporting ribs 122 are arranged symmetrically to each other.

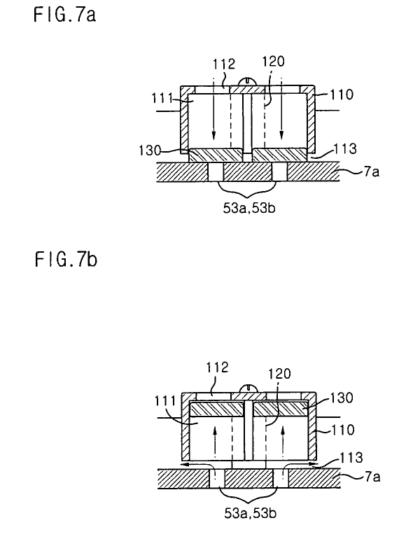

FIGS. 7A and 7B illustrate the operations of the dual-piston valve for orbiting vane compressors according to the first preferred embodiment of the present invention shown in FIG. 6. FIG. 7A is a sectional view illustrating the closing operation of the dual-piston valve, and FIG. 7B is a sectional view illustrating the opening operation of the dual-piston valve.

The valve housing 110 is mounted to the subsidiary bearing 7a above the inner and outer outlet ports 53a and 53b of the subsidiary bearing 7a via the fixing bosses 120. The gas outlet ports 113 are formed at opposite longitudinal sides of the valve housing 110 between the fixing bosses 120, and the pistons 130 are disposed in the piston operation spaces 111 of the valve housing 110, respectively.

As shown in FIG. 7A, the pistons 130 are moved downward by the pressure of the high-pressure refrigerant gas discharged from the discharge chamber and applied to the pistons 130 through the through-holes 112 of the valve housing 110, and therefore, the pistons 130 close the inner and outer outlet ports 53a and 53b of the subsidiary bearing 7a.

When the discharge pressure is applied to the pistons 130 through the inner and outer outlet ports 53a and 53b of the subsidiary bearing 7a, as shown in FIG. 7B, the pistons 130 are moved upward against the pressure of the high-pressure refrigerant gas discharged from the discharge chamber. As a result, the inner and outer outlet ports 53a and 53b of the subsidiary bearing 7a are opened. Consequently, the compressed refrigerant gas discharged through the inner and outer outlet ports 53a and 53b of the subsidiary bearing 7a is discharged into the discharge chamber through the gas outlet ports 113 of the valve housing 110.

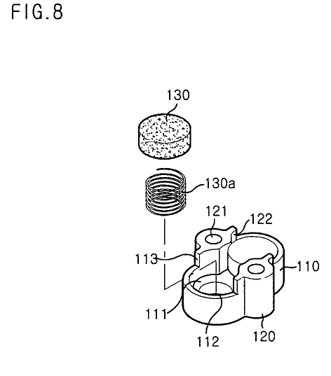

FIG. 8 is an exploded perspective view illustrating a dual-piston valve for orbiting vane compressors according to a second preferred embodiment of the present invention.

As shown in FIG. 8, the dual-piston valve comprises a valve housing 110, which is mounted to the subsidiary bearing 7a above the inner and outer outlet ports 53a and 53b of the subsidiary bearing 7a via fixing bosses 120. The valve housing 110 has a pair of piston operation spaces 111 defined therein. In the piston operation spaces 111 are movably disposed pistons 130, respectively. The piston operation spaces 111 communicate with the inner and outer outlet ports 53a and 53b of the subsidiary bearing 7a, respectively. At the lower end of the valve housing 110 are formed a pair of through-holes 112, which communicate with the piston operation spaces 111, respectively.

At the upper parts of opposite longitudinal sides of the valve housing 110 between the fixing bosses 120 are formed gas outlet ports 113. At the upper part of the outer circumference of each of the fixing bosses 120 are integrally formed one or more supporting ribs 122, by which the valve housing 110 is stably and securely fixed to the subsidiary bearing 7a. Preferably, at least two supporting ribs 122 are formed at the outer circumferential part of each of the fixing bosses 120 such that the supporting ribs 122 are arranged symmetrically to each other.

The dual-piston valve for orbiting vane compressors according to the second preferred embodiment of the present invention further comprises resilient supporting members disposed in the piston operation spaces 111 of the valve housing 110 between the through-holes 112 and the pistons 130, respectively, for resiliently supporting the corresponding pistons 130 in the direction in which the inner and outer outlet ports 53a and 53b of the subsidiary bearing 7a are closed. In the illustrated embodiment, each of the resilient supporting members is composed of a compression coil spring 130a, although the shape of the resilient supporting members is not limited so long as the resilient supporting members can properly function. Preferably, the diameter of the compression coil spring 130a is greater than that of the corresponding through-hole 112.

The dual-piston valve for orbiting vane compressors according to the second preferred embodiment of the present invention is characterized in that not only is pressure of the high-pressure refrigerant gas discharged from the discharge chamber applied to the pistons 130 but also the resilient force of the compression coil springs 130a is applied to the pistons 130. As a result, excessive application of the discharge pressure of the refrigerant gas, which is discharged through the inner and outer outlet ports 53a and 53b of the subsidiary bearing 7a, to the pistons 130 is prevented. Furthermore, repetitive collision of the pistons 130 and the valve housing 110 is prevented, and therefore, noise is greatly reduced.

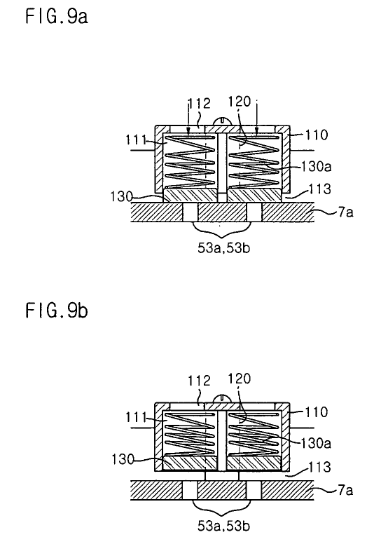

FIGS. 9A and 9B illustrate the operations of the dual-piston valve for orbiting vane compressors according to the second preferred embodiment of the present invention shown in FIG. 8. FIG. 9A is a sectional view illustrating the closing operation of the dual-piston valve, and FIG. 9B is a sectional view illustrating the opening operation of the dual-piston valve.

The valve housing 110 is mounted to the subsidiary bearing 7a above the inner and outer outlet ports 53a and 53b of the subsidiary bearing 7a via the fixing bosses 120. The gas outlet ports 113 are formed at the opposite longitudinal sides of the valve housing 110 between the fixing bosses 120. The pistons 130 and the compression coil springs 130a are disposed in the piston operation spaces 111 of the valve housing 110, respectively.

As shown in FIG. 9A, the pistons 130 are moved downward by the pressure of the high-pressure refrigerant gas discharged from the discharge chamber and applied to the pistons 130 through the through-holes 112 of the valve housing 110 and the resilient force of the compression coil springs 130a, and therefore, the pistons 130 close the inner and outer outlet ports 53a and 53b of the subsidiary bearing 7a.

When the discharge pressure is applied to the pistons 130 through the inner and outer outlet ports 53a and 53b of the subsidiary bearing 7a, as shown in FIG. 9B, the pistons 130 are moved upward against the pressure of the high-pressure refrigerant gas discharged from the discharge chamber and the resilient force of the compression coil springs 130a. As a result, the inner and outer outlet ports 53a and 53b of the subsidiary bearing 7a are opened. Consequently, the compressed refrigerant gas discharged through the inner and outer outlet ports 53a and 53b of the subsidiary bearing 7a is discharged into the discharge chamber through the gas outlet ports 113 of the valve housing 110.

As apparent from the above description, the present invention provides a dual-piston valve comprising a valve housing, which is formed in the shape of a cap, and pistons disposed in the valve housing for opening and closing inner and outer outlet ports of a subsidiary bearing. The valve housing is easily and conveniently mounted to the subsidiary bearing above the inner and outer outlet ports of the subsidiary bearing. Consequently, the present invention has the effect of accomplishing easy and convenient assembly of the valve at the inner and outer outlet ports of the subsidiary bearing. Also, compressed refrigerant gas is properly discharged. Consequently, the present invention has the effect of preventing performance of the orbiting vane compressor from being deteriorated due to over-compression loss of refrigerant gas.

Furthermore, not only is the pressure of the high-pressure refrigerant gas discharged from the discharge chamber applied to the pistons disposed in the valve housing but also the resilient force of the compression coil springs is applied to the pistons disposed in the valve housing. As a result, collision of the pistons and the valve housing is prevented. Consequently, the present invention has the effect of greatly reducing noise generated when the pistons disposed in the valve housing repetitively collide with the valve housing and improving operability and reliability of the dual-piston valve.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dual-piston valve for orbiting vane compressors comprising:
a valve housing having a pair of piston operation spaces defined therein, a pair of through-holes formed at one end thereof, which communicate with the piston operation spaces, respectively, and gas outlet ports formed at opposite longitudinal sides thereof; and
a pair of pistons disposed in the piston operation spaces of the valve housing such that the pistons can be vertically moved to open or close inner and outer outlet ports formed at a cylinder.

2. The valve as set forth in claim 1, wherein the gas outlet ports have heights less than those of the pistons.

3. The valve as set forth in claim 1, further comprising:
resilient supporting members disposed in the piston operation spaces of the valve housing between the through-holes and the pistons, respectively, for resiliently supporting the corresponding pistons in the direction in which the inner and outer outlet ports of the cylinder are closed.

4. The valve as set forth in claim 3, wherein
the resilient supporting members are compression coil springs, and
each of the compression coil springs has a diameter greater than that of the corresponding through-hole.

5. The valve as set forth in claim 4, wherein each of the through-holes has a diameter less than that of the corresponding piston operation space.

6. The valve as set forth in claim 1, further comprising:
fixing members for fixing the valve housing to the cylinder above the inner and outer outlet ports of the cylinder.

7. The valve as set forth in claim 6, wherein the fixing members are fixing bosses integrally formed at the valve housing, the fixing bosses being disposed at opposite lateral sides of the valve housing between the through-holes in the direction perpendicular to the line connecting the centers of the through-holes.

8. The valve as set forth in claim 7, wherein each of the fixing bosses has at least two supporting ribs integrally formed at the upper or lower part of the outer circumference thereof such that the supporting ribs are arranged symmetrically to each other.

9. An orbiting vane compressor comprising:
a cylinder having an inlet port formed at a predetermined position of the circumferential part thereof and inner and outer outlet ports formed at predetermined positions of the upper end thereof;
an annular operation space defined between an inner wall of the cylinder and an inner ring;
a wrap of an orbiting vane disposed in the operation space for forming inner and outer compression chambers at the inside and the outside of the wrap, respectively, the inner and outer compression chambers communicating with the inner and outer outlet ports of the cylinder; and
a dual-piston valve mounted at the inner and outer outlet ports of the cylinder, wherein the dual-piston valve comprises:
a valve housing having a pair of piston operation spaces defined therein, a pair of through-holes formed at one end thereof, which communicate with the piston operation spaces, respectively, and gas outlet ports formed at opposite longitudinal sides thereof; and
a pair of pistons disposed in the piston operation spaces of the valve housing such that the pistons can be vertically moved to open or close the inner and outer outlet ports of the cylinder.

10. The compressor as set forth in claim 9, wherein the gas outlet ports have heights less than those of the pistons.

11. The compressor as set forth in claim 9, wherein the dual-piston valve further comprises:
resilient supporting members disposed in the piston operation spaces of the valve housing between the through-holes and the pistons, respectively, for resiliently supporting the corresponding pistons in the direction in which the inner and outer outlet ports of the cylinder are closed.

12. The compressor as set forth in claim 11, wherein
the resilient supporting members are compression coil springs, and
each of the compression coil springs has a diameter greater than that of the corresponding through-hole.

13. The compressor as set forth in claim 12, wherein each of the through-holes has a diameter less than that of the corresponding piston operation space.

14. The compressor as set forth in claim 9, wherein the dual-piston valve further comprises:
fixing members for fixing the valve housing to the cylinder above the inner and outer outlet ports of the cylinder.

15. The compressor as set forth in claim 14, wherein the fixing members are fixing bosses integrally formed at the valve housing, the fixing bosses being disposed at opposite lateral sides of the valve housing between the through-holes in the direction perpendicular to the line connecting the centers of the through-holes.

16. The compressor as set forth in claim 15, wherein each of the fixing bosses has at least two supporting ribs integrally formed at the upper or lower part of the outer circumference thereof such that the supporting ribs are arranged symmetrically to each other.
